(19) United States
(12) Patent Application Publication
(10) Pub. No.: US 2009/0113887 A1
(43) Pub. Date: May 7, 2009

(54) Hydraulic Drive Device

(75) Inventors: Kiwamu Takahashi, Ibaraki (JP); Yasutaka Tsuruga, Ibaraki (JP); Junya Kawamoto, Ibaraki (JP); Kenji Itou, Ibaraki (JP); Takuya Matsui, Ibaraki (JP)

Correspondence Address: CROWELL & MORING LLP;INTELLECTUAL PROPERTY GROUP, P.O. BOX 14300, WASHINGTON, DC, 20044-4300, US

(73) Assignee: HITACHI CONSTRUCTION MACHINERY CO., LTD., Tokyo (JP)

(21) Appl. No.: 11/795,968

(22) PCT Filed: Jan. 24, 2006
(86) PCT No.: PCT/JP06/01027

§ 371 Date: Sep. 9, 2008

(30) Foreign Application Priority Data
Jan. 26, 2005 (JP) 2005-018421

(51) Int. Cl. F15B 11/02; F15B 11/17

(52) U.S. Cl. 60/420

(57) ABSTRACT

To permit driving a tilt cylinder and an angle cylinder at relatively low speed and also to permit driving an additional actuator at high speed.

Provided are a tilt cylinder 9 and angle cylinder 10 for pivotally tilting a blade 7 selectively leftward and rightward and for pivotally angling the blade 7 selectively forward and rearward, respectively, and an additional actuator for actuating an additional attachment. Also provided are a tilting/angling pressure oil feed means comprising a tilting/angling directional control valve 19 for controlling a flow of pressure oil to be fed to one of the cylinders 9,10 and a selector valve 20 for selectively feeding pressure oil, which flows out of the directional control valve 19, to one of the cylinders 9,10. An additional pressure oil feed means for feeding pressure oil to the additional actuator 27 is provided independently of the tilting/angling directional control valve, and the additional pressure oil feed means has an additional directional control valve 29.

### TECHNICAL FIELD

This invention relates to a hydraulic drive system, which is to be arranged on a hydraulic excavator, has a blade cylinder, tilt cylinder and angle cylinder for positioning a blade, and also has an additional actuator for driving an additional attachment such as a hydraulic crusher.

### BACKGROUND ART

As a conventional technology of this kind, there is one disclosed in Patent Document 1. FIG. 7 is a hydraulic circuit diagram illustrating the conventional hydraulic drive system disclosed in Patent Document 1.

This conventional technology is provided with a blade cylinder 8 for selectively pivotally raising and lowering a blade, a tilt cylinder 9 for pivotally tilting the blade selectively leftward and rightward, an angle cylinder 10 for pivotally angling the blade selectively forward and rearward, and an additional actuator for driving an additional actuator such as a hydraulic crusher.

Also provided are a first hydraulic pump 12, a second hydraulic pump 13, and an auxiliary hydraulic pump 14. Also provided are a directional control valve 18 for the blade, which is connected to the second hydraulic pump 13 and controls a flow of pressure oil to be fed to the blade cylinder 8, a tilting/angling directional control valve 19 connected to the first hydraulic pump 12, and a selector valve 20 arranged in lines 28a,28b, which communicate the tilting/angling directional control valve 19 and the tilt cylinder 9 and angle cylinder 10, respectively, to selectively feed pressure oil, which flows out of the tilting/angling directional control valve 19, to one of the tilt cylinder 9 and angle cylinder 10. Further provided is another selector valve 20a arranged in the lines 28a,28b, which communicate the selector valve 20 and the tilting/angling directional control valve 19 with each other, to selectively feed pressure oil, which flows out of the tilting/angling directional control valve 19, to one of the selector valve 20 and the additional actuator 27. Between the selector valve 20a and the additional actuator 27, a selector valve 31 is arranged. This selector valve 31 can selectively cut off and communicate the line that connects the selector valve 20a and the additional actuator 27 with each other, and during a cut-off, connects the additional actuator 27 to a reservoir 32. It is to be noted that the selector valve 20a and the directional control valve 18 for the blade and the corresponding ones of the blade cylinder 8 and selector valve 20 are connected together via a swivel joint 24.

The above-mentioned first hydraulic pump 12, tilting/angling directional control valve 19, selector valve 20, selector valve 20a and selector valve 31 constitute a tilting/angling pressure oil feed means, which selectively feeds pressure oil to one of the tilt cylinder 9 and angle cylinder 10, and also, another pressure oil feed means for the additional actuator (hereinafter simply called “the additional pressure oil feed means”) for selectively feeding pressure oil to the additional actuator 27.

Still further provided are a pilot valve 25 for switching the directional control valve 18 for the blade, a pilot valve 26 for switching the tilting/angling directional control valve 19 upon driving the tilt cylinder 9 or angle cylinder 10, and a pilot valve 30 for switching the tilting/angling directional control valve 19 upon driving the additional actuator 27. One of a secondary pressure outputted from the pilot valve 26 and a secondary pressure outputted from the pilot valve 30 is, therefore, applied via a shuttle valve 33a or 33b to a corresponding control chamber of the tilting/angling directional control valve 19.

Still further provided are an electrical system, which is connected to a power supply 23, includes a switch 23a, relay 22 and solenoid valve 21 and serves to switch the selector valve 20, and another electrical system, which is connected to the power supply 23, includes a switch 23b, relay 22a and solenoid valves 21a,21b and serves to switch the selector valve 20a.

### Patent Document 1: JP-A-2002-38534

### DISCLOSURE OF THE INVENTION

### Problems to be Solved by the Invention

The above-mentioned conventional technology is accompanied by a problem in that the flow rate of pressure oil to be fed to the additional actuator 27 is limited by the tilting/angling directional control valve 19, because the another selector 20a for selectively feeding pressure oil to the additional actuator 27 is arranged between the tilting/angling directional control valve 19 and the selector valve 20. It is generally desired to perform, at relatively low speed, a tilting operation of the blade by an actuation of the tilt cylinder 9, that is, pivotal leftward or rightward tilting of the blade and an angling operation of the blade by an actuation of the angle cylinder 10, that is, pivotal forward or rearward angling of the blade. In contrast, the additional actuator 27 which actuates an additional attachment such as a hydraulic crusher is driven at relatively high speed in many instances.

When the ratio of valve opening area to spool stroke in the tilting/angling directional control valve 19 is set relatively small, the output flow rate of the tilting/angling directional control valve 19, therefore, becomes a low flow rate corresponding to an operation of the pilot valve 26. A tilting/angling operation can hence be performed well, but the operation speed of the additional actuator 27 is lowered, leading to a reduction in the efficiency of work by the additional attachment as performed by the operation of the additional actuator 27.

When the ratio of valve opening area to spool stroke in the tilting/angling directional control valve 19 is set relatively large, on the other hand, the output flow rate of the tilting/angling directional control valve 19, therefore, becomes a high flow rate corresponding to an operation of the pilot valve 30. Accordingly, the operation speed of the additional actuator 27 can be accelerated, and the efficiency of work by the additional attachment as driven by the additional actuator 27 can be improved. However, a tilting/angling operation is performed at very high speed, leading to a reduction in the controllability of the tilting/angling operation.

With the above-mentioned circumstances of the conventional technology in view, the present invention has as an object thereof the provision of a hydraulic drive system capable of driving a tilt cylinder and angle cylinder at relatively low speed and an additional actuator at high speed.

### Means for Solving the Problems

To achieve the above-described object, the present invention is characterized in that, in a hydraulic drive system provided with a blade cylinder for selectively pivotally raising and lowering a blade, a tilt cylinder for pivotally tilting the blade selectively leftward and rightward, an angle cylinder for pivotally angling the blade selectively forward and rearward and an additional actuator for actuating an additional attachment and also provided with a tilting/angling pressure oil feed means comprising a tilting/angling directional control valve for controlling a flow of pressure oil to be fed to one of the tilt cylinder and angle cylinder and a selector valve arranged between the tilting/angling directional control valve and the tilt cylinder and angle cylinder to selectively feed pressure oil, which flows out of the tilting/angling directional control valve, to one of the tilt cylinder and the angle cylinder, an additional pressure oil feed means for feeding pressure oil to the additional actuator is arranged independently of the tilting/angling directional control valve, and the additional pressure oil feed means has an a directional control valve for the additional actuator (hereinafter simply called “the additional directional control valve”) for controlling a flow of pressure oil to be fed to the additional actuator.

When driving the tilt cylinder or angle cylinder, the present invention constructed as described above makes it possible to feed pressure oil at relatively low flow rate to the tilt cylinder or angle cylinder via the tilting/angling directional control valve and selector valve included in the tilting/angling pressure oil feed means arranged independently of the additional pressure oil feed means. The tilt cylinder or angle cylinder can hence be driven at relatively low speed. When driving the additional actuator, on the other hand, it is possible to feed pressure oil at relatively high flow rate to the additional actuator via the additional directional control valve, which is included in the additional pressure oil feed means arranged independently of the tilting/angling pressure oil feed means, by switching the additional directional control valve. The additional actuator can, therefore, be driven at high speed.

The present invention is also characterized in that in the invention described above, the additional pressure oil feed means has a first hydraulic pump for feeding pressure oil to the additional directional control valve, the tilting/angling pressure oil feed means has a second hydraulic pump for feeding pressure oil to the tilting/angling directional control valve, and the first hydraulic pump is a hydraulic pump greater in delivery rate than the second hydraulic pump.

When driving the additional actuator, the present invention constructed as described above makes it possible to feed pressure oil at high flow rate from the first hydraulic pump, which is high in delivery rate, to the additional actuator by switching the additional directional control valve. The additional actuator can, therefore, be driven at high speed. When driving the tilt cylinder or angle cylinder, it is possible to feed pressure oil at low flow rate from the second hydraulic pump, which is lower in delivery rate than the first hydraulic pump, to the tilt cylinder or angle cylinder by switching the tilting/angling directional control valve. The tilt cylinder or angle cylinder can, therefore, be driven at relatively low speed.

The present invention is also characterized in that in the invention described above, the additional pressure oil feed means has a hydraulic pump for feeding pressure oil to the additional directional control valve, and the tilting/angling pressure oil feed means has a hydraulic pump for feeding pressure oil to the tilting/angling directional control valve, the hydraulic pump in the additional pressure oil feed means and the hydraulic pump in the tilting/angling pressure oil feed means are the same with each other, and a ratio of valve opening area to spool stroke in the additional directional control valve is set greater than a ratio of valve opening area to spool stroke in the tilting/angling directional control valve.

As a result of switching of the additional directional control valve, the present invention constructed as described above makes it possible to feed pressure oil from the additional directional control valve to the additional actuator at high flow rate corresponding to the relatively large ratio of valve opening area to spool stroke. As a result of switching of the tilting/angling directional control valve, on the other hand, it is possible to feed pressure oil from the tilting/angling directional control valve to the tilt cylinder or angle cylinder at low flow rate corresponding to the relatively small ratio of valve opening area to spool stroke.

The present invention is also characterized in that in the invention described above, the additional pressure oil feed means comprises a selector valve, which is arranged between the additional actuator and the additional directional control valve, can selectively cut off and communicate a line that connects the additional actuator and the additional directional control valve with each other, and during a cut-off, connects the additional actuator to a reservoir.

When the selector valve is switched to bring the additional actuator and the additional directional control valve into communication with each other, the present invention constructed as described above makes it possible to feed pressure oil to the additional actuator via the additional directional control valve. When the selector valve is switched to cut off the additional actuator and the additional directional control valve from each other, the additional actuator is brought into communication with the reservoir, thereby making it possible to perform, for example, the lowering or the like of the additional attachment, which is driven by the additional actuator, by its own weight.

### Advantageous Effects of the Invention

According to the present invention, the additional pressure oil feed means for feeding pressure oil to the additional actuator is provided independently of the tilting/angling pressure oil feed means that selectively feed pressure oil to one of the tilt cylinder and angle cylinder. It is, therefore, possible to feed pressure oil at low flow rate to the tilt cylinder or angle cylinder by the tilting/angling pressure oil feed means and to drive the tilt cylinder or angle cylinder at relatively low speed. It is also possible to feed pressure oil at very high flow rate to the additional actuator by the additional pressure oil feed means and to drive the additional actuator at high speed. Owing to these features, it is possible to realize both of improvements in the controllability of a tilting/angling operation and improvements in the efficiency of work by the additional attachment driven by the additional actuator, although these improvements have heretofore been hardly realized together.

### Best Mode for Carrying out the Invention

Based on drawings, a description will hereinafter be made of best modes for carrying out the hydraulic drive system according to the present invention.

FIG. 1 is a side view showing one example of a hydraulic excavator on which a first embodiment of the hydraulic drive system according to the present invention is to be arranged, and FIG. 2 is a plan view depicting a lower part of the hydraulic excavator shown in FIG. 1.

As shown in these FIGS. 1 and 2, the hydraulic excavator on which the first embodiment of the present invention is to be arranged is provided with a travel base 1 and a swing upper structure 2 mounted on the travel base 1, and a seat 3 is mounted on the swing upper structure 2. A vertically-pivotable boom 4 is connected to the swing upper structure 2, a vertically-pivotable arm 5 is connected to the boom 4, and a vertically-pivotable-bucket 6 is connected to the arm 5. By these boom 4, arm 5 and bucket 6, a front attachment which can perform digging work or the like is constructed. Further, the detachment of the bucket 6 makes it possible to mount an additional attachment such as a hydraulic crusher. It is to be noted that in the following description, an additional attachment such as a hydraulic crusher can be mounted in place of the bucket 6.

In front of the travel base 1, there are also arranged, in addition to a blade 7, a blade cylinder 8 for selectively pivotally raising and lowering the blade 7, a tilt cylinder for pivotally tilting the blade selectively leftward and rightward, and an angle cylinder 10 for pivotally angling the blade selectively forward and rearward.

FIG. 3 is a hydraulic circuit diagram showing the first embodiment of the hydraulic drive system according to the present invention, FIG. 4 is a diagram illustrating output characteristics of a pilot valve for operating a directional control valve for the blade, said directional control valve being arranged in the first embodiment according to the present invention, and output characteristics of a pilot valve for operating a tilting/angling directional control valve, and FIG. 5 is a diagram illustrating output characteristics of a pilot valve for operating a directional control valve for an additional actuator, said directional control valve being arranged in the first embodiment of the present invention.

Described specifically, the first embodiment is also provided with a first hydraulic pump, a second hydraulic pump 13 and an auxiliary pump 14, all of which are driven by an engine 1. It is to be noted that in the first embodiment, the first hydraulic pump 12 consists of a hydraulic pump greater in delivery rate than the second hydraulic pump 13. The delivery pressures of these pumps 12,13,14 are controlled by their corresponding relief valves 15,16,17, respectively.

This first embodiment is also provided with a directional control valve 18 for the blade, which controls a flow of pressure oil to be fed to the blade cylinder 8, a tilting/angling directional control valve 19 for controlling a flow of pressure oil to be fed to the tilt cylinder 9 or angle cylinder 10, and an additional actuator 27 for driving the above-mentioned additional attachment. Specifically, this first embodiment is provided with a directional control valve 29 for the additional actuator (hereinafter simply called “the additional directional control valve 29), which controls a flow of pressure oil to be fed to the additional actuator 27. Further, the first hydraulic pump 12 and the additional directional control valve 29 are connected with each other, and the directional control valve 28 for the blade and tilting/angling directional control valve 19 and the second hydraulic pump 13 are connected with each other.

Lines 28a,28b, which connect the tilting/angling directional control valve 19 and the tilt cylinder 9 and angle cylinder 10, respectively, are provided with a selector valve 20 for selectively feeding pressure oil, which flows out of the tilting/angling directional control valve 19, to one of the tilt cylinder 9 and angle cylinder 10. Between the above-mentioned additional directional control valve 29 and the above-mentioned additional actuator 27, there is arranged a selector valve 31 which can cut off or communicate a line connecting the additional directional control valve 29 and the additional actuator 27 with each other and during a cut-off, connects the additional actuator to a reservoir 32.

Also provided are a pilot valve 25 for switching the directional control valve 18 for the blade, a pilot valve 26 for switching the tilting/angling directional control valve 19, and a pilot valve 30a for switching the additional directional control valve 29.

The output characteristics of the pilot valve 25 are set as indicated by sign A in FIG. 4, while the output characteristics of the pilot valve 26 are set as indicated by sign B in FIG. 4. In these characteristics A,B, the gradients are relatively gentle. The output characteristics of the pilot valve 30a, on the other hand, are set such that as indicated by sign C in FIG. 5, they have a greater gradient compared with the output characteristics B in FIG. 4.

The tilting/angling directional control valve 19 and the directional control valve 18 for the blade are connected with the corresponding ones of the blade cylinder 8 and selector valve 20 via a swivel joint 24, respectively.

Further provided are an electrical system, which is connected to a power supply 23, includes a switch 23a, relay 22 and solenoid valve 22, and switches the selector valve 20.

By the above-mentioned second hydraulic pump 13, tilting/angling directional control valve 19 and selector valve 20, a tilting/angling pressure oil feed means is constructed to selectively feed pressure oil to one of the tilt cylinder 9 and angle cylinder 10. By the first hydraulic pump 12, the additional directional control valve 29 and a selector valve 31, on the other hand, an additional pressure oil feed means is constructed to feed pressure oil to the additional actuator 27. Namely, this first embodiment is constructed with the tilting/angling pressure feed means and the additional pressure oil feed means being arranged independently of each other.

In the first embodiment constructed as described above, an operation of the pilot valve 25 causes pressure oil, which has been delivered from the auxiliary hydraulic pump 14, to be applied as a secondary pressure, in other words, a pilot pressure to the control chamber of the directional control valve 18 for the blade so that the directional control valve 18 for the blade is switched. As a result, pressure oil delivered from the second hydraulic pump 13 is fed to the blade cylinder 8 via the directional control valve 18 for the blade to actuate the blade cylinder 8. As a consequence, the blade 7 shown in FIGS. 1 and 2 can be pivotally moved in the vertical direction.

In a state that the switch 23a is maintained open as shown in FIG. 3, the solenoid valve 31a assumes the right position illustrated in FIG. 3, so that the pressure oil from the auxiliary hydraulic pump 14 is not fed to the control chamber of the selector valve 20 and the selector valve 20 is maintained in the right position shown in FIG. 3. When the pilot valve 26 is operated in this state, a secondary pressure is applied to the control chamber of the tilting/angling directional control valve 19, and the tilting/angling directional control valve 19 is switched. As a result, the pressure oil delivered from the second hydraulic pump 13 is fed to the tilt cylinder 9 via the tilting/angling directional control valve 19 and selector valve 20 to actuate the tilt cylinder 9. As a consequence, the blade 7 shown in FIGS. 1 and 2 is pivotally tilted leftward or rightward to perform a tilting operation.

When the switch 23a is closed, on the other hand, the solenoid valve 21 is switched to the left position shown in FIG. 3 by a signal fed via the relay 22. As a result, the pressure oil delivered from the auxiliary hydraulic pump 14 is fed to the control chamber of the selector valve 20 via the solenoid valve 21 to switch the selector valve 20 to the left position in FIG. 3. When the pilot valve 26 is operated in this state, a secondary pressure is applied to the tilting/angling directional control valve 19 to switch the tilting/angling directional control valve 19. As a result, the pressure oil delivered from the second hydraulic pump 13 is fed to the angle cylinder 10 via the tilting/angling directional control valve 19 and selector valve 20 to actuate the angle cylinder 10. As a consequence, the blade 7 shown in FIGS. 1 and 2 is pivotally angled forward or rearward.

Upon performing the above-mentioned tilting operation or angling operation, a secondary pressure of the gentle-gradient characteristics B is fed to the control chamber of the tilting/angling directional control valve 19 and the pressure oil from the second hydraulic pump 13 of low delivery rate is also fed to the tilting/angling directional control valve 19. The pressure oil is, therefore, fed at a relatively low flow rate to the tilt cylinder 9 or angle cylinder 10.

When the pilot valve 30a is operated, a secondary pressure is applied to the control chamber of the additional directional control valve 29 so that the additional directional control valve 29 is switched. As a result, the pressure oil delivered from the first hydraulic pump 12 is fed to the additional actuator 27 to operate the additional actuator 27. As a consequence, the unillustrated additional attachment can be driven.

Upon performing the above-mentioned operation, a secondary pressure of the large-gradient characteristics C is fed to the control chamber of the additional directional control valve 29 and the pressure oil from the first hydraulic pump 12 of high delivery rate is also fed to the additional directional control valve 29. The pressure oil is, therefore, fed at a relatively high flow rate to the additional actuator 24.

According to the first embodiment constructed as described above, when driving the tilt cylinder 9 or angle cylinder 10, the pressure oil from the secondary hydraulic pump 13 of low delivery rate is fed via the tilting/angling directional control valve 19 and selector valve 20, both of which are included in the tilting/angling pressure oil feed means arranged independently of the additional pressure oil feed means. As a result, the pressure oil can be fed at a relatively low flow rate to the tilt cylinder 9 or angle cylinder 10. Therefore, the tilt cylinder 9 or angle cylinder 10 can be driven at a relatively low speed. When driving the additional actuator 27, on the other hand, switching of the additional directional control valve 29, which is included in the additional pressure oil feed means arranged independently of the tilting/angling pressure oil feed means, makes it possible to feed the pressure oil from the first hydraulic pump of high delivery rate via the additional directional control valve 29 and hence, to feed the pressure oil at a high flow rate to the additional actuator 27. Therefore, the additional actuator 27 can be driven at a high speed. Owing to these features, it is possible to realize both of improvements in the controllability of a tilting/angling operation and improvements in the efficiency of work by the unillustrated additional attachment driven by the additional actuator 27.

It is to be noted that, because no electrical system is included in the additional pressure oil feed means, it is possible to obviate any electrical parts and complex wiring structure which would otherwise be required.

FIG. 6 is a hydraulic circuit diagram illustrating a second embodiment of the present invention. Load sensing control which is control performed in accordance with a differential pressure between a pump delivery pressure and a maximum load pressure on a circuit is performed in this second embodiment.

Described specifically, in this second embodiment, the directional control valve 18 for the blade, the tilting/angling directional control valve 19 and the additional directional control valve 29 are connected to a variable displacement hydraulic pump 35. The hydraulic pump 35, therefore, serves not only an element of the tilting/angling pressure oil feed means but also an element of the additional pressure oil feed means. The delivery pressure of this hydraulic pump 35 is controlled by a relief valve 36.

For example, on upstream sides of the directional control valve 18 for the blade, the tilting/angling directional control valve 19 and the additional directional control valve 29, pressure compensator valves 18a,19a,29awhich operate in accordance with pressure differentials between upstream-side pressures and downstream-side pressures of the respective directional control valves 18,19,29 are arranged. Also arranged are shuttle valves 38a,38b for selecting maximum load pressures of their corresponding circuits and an unloading valve 37 operable responsible to a differential pressure between the delivery pressure of the hydraulic pump 35 and the maximum load pressure on the circuit. Further arranged is a regulator 35a, which regulates the delivery rate of the hydraulic pump 35 in accordance with the differential pressure between the delivery pressure of the hydraulic pump and the maximum load pressure.

Specifically, this second embodiment is designed in such a construction that the ratio of valve opening area to spool stroke in the additional directional control valve 29 is set greater than the ratio of valve opening area to spool stroke in the tilting/angling directional control valve 19. The remaining construction is similar to the corresponding construction in the above-mentioned first embodiment.

In the second embodiment constructed as described above, when the pilot valve 30a is operated to switch the additional directional control valve 29, the pressure oil can be fed at a high flow rate to the additional actuator 27 owing to the relatively large ratio of valve opening area to spool stroke in the additional directional control valve 29. As a consequence, the additional actuator 27 can be driven at a high speed. When the pilot valve 26 is operated to switch the tilting/angling directional control valve 19, the pressure oil can be fed at a low flow rate to the tilt cylinder 9 or angle cylinder 10 owing to the relatively small ratio of valve opening area to spool stroke in the tilting/angling directional control valve 19. As a consequence, the cylinder 9 or 10 can be driven at a relatively low speed. As in the above-mentioned first embodiment, the second embodiment can also realize both of improvements in the controllability of a tilting/angling operation and improvements in the efficiency of work by the unillustrated additional attachment driven by the additional actuator 27.

### BRIEF DESCRIPTION OF THE DRAWINGS

FIG. 1 A side view showing one example of a hydraulic excavator on which a first embodiment of the hydraulic drive system according to the present invention is to be arranged.

FIG. 2 A plan view depicting a lower part of the hydraulic excavator shown in FIG. 1.

FIG. 3 A hydraulic circuit diagram showing the first embodiment of the hydraulic drive system according to the present invention.

FIG. 4 A diagram illustrating output characteristics of a pilot valve for operating a directional control valve for the blade, said directional control valve being arranged in the first embodiment according to the present invention, and output characteristics of a pilot valve for operating a tilting/angling directional control valve.

FIG. 5 A diagram illustrating output characteristics of a pilot valve for operating a directional control valve for an additional actuator, said directional control valve being arranged in the first embodiment of the present invention.

FIG. 6 A hydraulic circuit diagram illustrating a second embodiment of the present invention.

FIG. 7 A hydraulic circuit diagram illustrating a conventional hydraulic drive system.

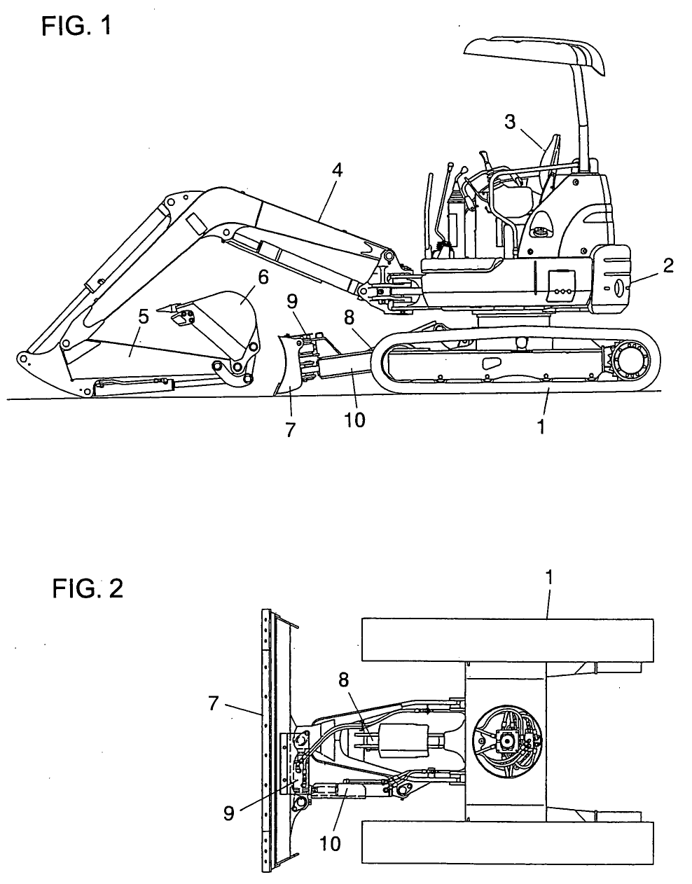

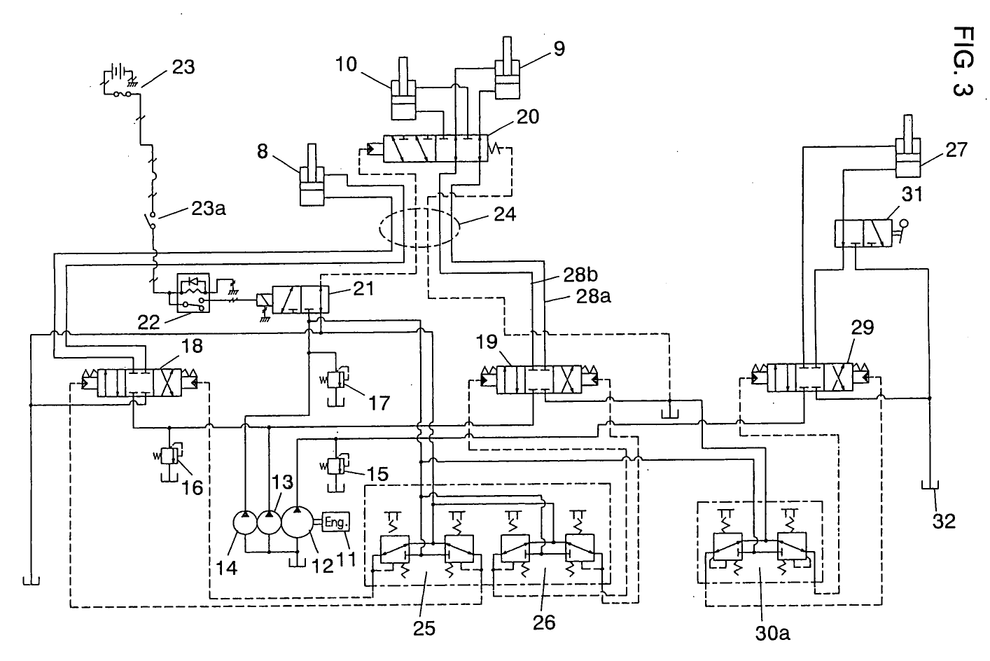

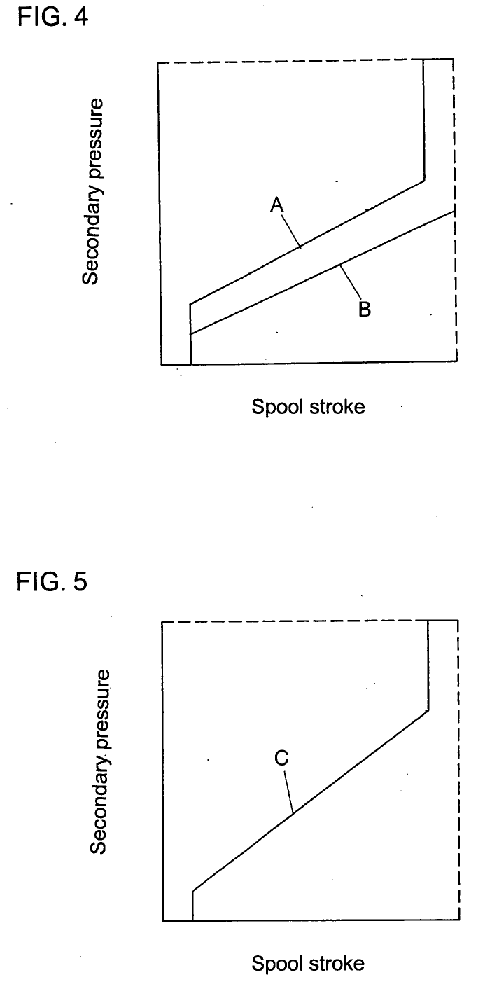

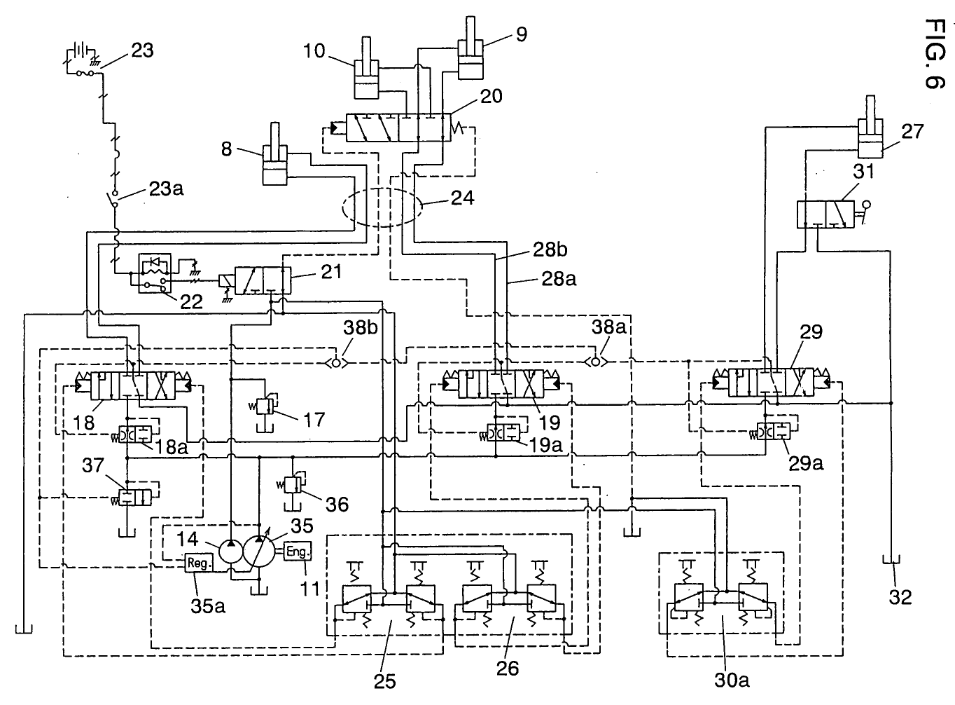

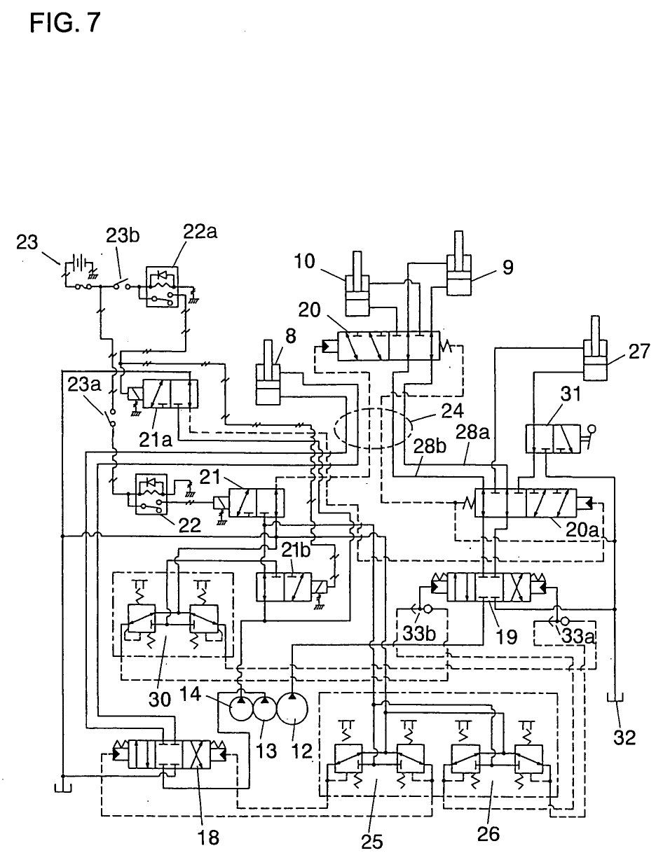

### LEGEND

7 Blade

8 Blade cylinder

9 Tilt cylinder

10 Angle cylinder

12 First hydraulic pump (pressure oil feed means for an additional actuator)

13 Second hydraulic pump (tilting/angling pressure oil feed means)

14 Auxiliary hydraulic pump

18 Directional control valve for the blade

19 Tilting/angling directional control valve (tilting/angling pressure oil feed means)

20 Selector valve (tilting/angling pressure oil feed means)

21 Solenoid valve

22 Relay

23 Power supply

23a Switch

25 Pilot valve

26 Pilot valve

27 Additional actuator

28a Line

28b Line

29 Directional control valve for the additional actuator (pressure oil feed means for the additional actuator)

30a Pilot valve

31 Selector valve (pressure oil feed means for the additional actuator)

32 Reservoir

33 Hydraulic pump (tilting/angling pressure oil feed means, pressure oil feed means for the additional actuator)

35a Regulator

1. A hydraulic drive system provided with a blade cylinder for selectively pivotally raising and lowering a blade, a tilt cylinder for pivotally tilting said blade selectively leftward and rightward, an angle cylinder for pivotally angling said blade selectively forward and rearward and an additional actuator for actuating an additional attachment and also provided with a tilting/angling pressure oil feed means comprising a tilting/angling directional control valve for controlling a flow of pressure oil to be fed to one of said tilt cylinder and angle cylinder and a selector valve arranged between said tilting/angling directional control valve and said tilt cylinder and angle cylinder to selectively feed pressure oil, which flows out of said tilting/angling directional control valve, to one of said tilt cylinder and said angle cylinder, wherein:
an additional pressure oil feed means for feeding pressure oil to said additional actuator is arranged independently of said tilting/angling directional control valve, and said additional pressure oil feed means has an additional directional control valve for controlling a flow of pressure oil to be fed to said additional actuator.

2. The invention as described above in claim 1, wherein:
said additional pressure oil feed means has a first hydraulic pump for feeding pressure oil to said additional directional control valve, said tilting/angling pressure oil feed means has a second hydraulic pump for feeding pressure oil to said tilting/angling directional control valve, and said first hydraulic pump is a hydraulic pump greater in delivery rate than said second hydraulic pump.

3. The invention as described above in claim 1, wherein:
said additional pressure oil feed means has a hydraulic pump for feeding pressure oil to said additional directional control valve, and said tilting/angling pressure oil feed means has a hydraulic pump for feeding pressure oil to said tilting/angling directional control valve,
said hydraulic pump in said additional pressure oil feed means and said hydraulic pump in said tilting/angling pressure oil feed means are the same with each other, and
a ratio of valve opening area to spool stroke in said additional directional control valve is set greater than a ratio of valve opening area to spool stroke in said tilting/angling directional control valve.

4. The invention as described above in claim 1, wherein:
said additional pressure oil feed means comprises a selector valve, which is arranged between said additional actuator and said additional directional control valve, can selectively cut off and communicate a line that connects said additional actuator and said additional directional control valve with each other, and during a cut-off, connects said additional actuator to a reservoir.

5. The invention as described above in claim 2, wherein:
said additional pressure oil feed means comprises a selector valve, which is arranged between said additional actuator and said additional directional control valve, can selectively cut off and communicate a line that connects said additional actuator and said additional directional control valve with each other, and during a cut-off, connects said additional actuator to a reservoir.

6. The invention as described above in claim 3, wherein:
said additional pressure oil feed means comprises a selector valve, which is arranged between said additional actuator and said additional directional control valve, can selectively cut off and communicate a line that connects said additional actuator and said additional directional control valve with each other, and during a cut-off, connects said additional actuator to a reservoir.
